(19) United States
(12) Patent Application Publication
(10) Pub. No.: US 2017/0262624 A1
(43) Pub. Date: Sep. 14, 2017

(54) ACCESS CONTROL SYSTEM

(71) Applicant: Intel Corporation, Santa Clara, CA (US)

(72) Inventor: Shoumeng Yan, Beijing (CN)

(21) Appl. No.: 15/121,642

(22) PCT Filed: Sep. 25, 2015
(86) PCT No.: PCT/CN2015/090744

§ 371 Date: Aug. 25, 2016

(51) Int. Cl. G06F 21/36; G06F 3/0488

(52) U.S. Cl. CPC G06F 21/36; G06F 3/04883

(57) ABSTRACT

Various systems and methods for providing access control are described herein. A system comprises a display; a processor; and a memory, including instructions, which when executed on the processor, cause the processor to: present a limited lock screen on a display of the user device, wherein the limited lock screen only provides a non-personalized access mechanism; receive user input via the limited lock screen; correlate the user input with an operating context, wherein the user input is uniquely correlated with the operating context; and unlock the user device with access to the operating context.

### TECHNICAL FIELD

Embodiments described herein generally relate to device access controls and in particular, to an access control system.

### BACKGROUND

Use of a login or lock screen is common among computing platforms. Mobile devices typically include a lock mechanism to lock the system from access. A lock screen is used to provide the user a way to access the locked system. The lock screen may include multiple icons, one for each account on the system. Alternatively, the lock screen may include a personal identification number (PIN) pad to enter a sequence of numbers or a pattern in order to unlock the system.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating data and control flow, according to an embodiment;

FIG. 2 is a diagram illustrating a user interface, according to an embodiment;

FIG. 3 is a diagram illustrating a user interface, according to an embodiment;

FIG. 4 is a diagram illustrating a user interface, according to an embodiment;

FIG. 5 is a block diagram illustrating a system for access control, according to an embodiment;

FIG. 6 is a block diagram illustrating a system for access control, according to an embodiment;

FIG. 7 is a flowchart illustrating a method of providing access control to a user device, according to an embodiment; and

FIG. 8 is a block diagram illustrating an example machine upon which any one or more of the techniques (e.g., methodologies) discussed herein may perform, according to an example embodiment.

### DETAILED DESCRIPTION

Systems and methods described herein provide mechanisms for access control. Many devices, such as smartphones, tablets, or laptops, use a lock screen, which the user interfaces with to unlock the device. Lock screens may use a personal identification number (PIN), password, swipe pattern, fingerprint scan, or other mechanism to access the device.

Some devices or operating systems provide multiple operating contexts (e.g., user accounts, modes of operation, or the like). In such devices, to access one of the operating contexts, the user first selects the operating context (e.g., selects a user account), and then provides a proper authentication, such as a password. In these multi-operating context devices, exposing the existence of the multiple available operating contexts (e.g., each users' login name or identity) may create a security weakness. Thus, what is needed is a mechanism to provide access control to a multi-operating context device without explicitly listing the available operating contexts.

Mobile devices are becoming powerful enough to execute multiple instances, virtual machines (VMs), or accounts on a single device. For the purposes of this document, each of these may be referred to as an operating context. An operating context includes a configuration, mode of operation, security settings, and the like to provide a distinct user interface and related functionality to a user. Examples of operating contexts include, but are not limited to a user account, an instance of an operating system, an instance of a virtual machine, a private operating mode, a public operating mode, a limited operating mode, and a guest operating mode.

Current devices that support multiple operating contexts have the user first select an identity or mode, then provide some access control input. For example, in WINDOWS®, a user may first click on an icon with their username and then type in a password in the password prompt that appears. As such, users of current devices are able to perceive the existence of all of the operating contexts (e.g., user accounts) of the device.

The systems described herein do not explicitly display (e.g., divulge) the available operating contexts of a device, but instead just shows a screen lock where a user may input an access mechanism. When the input matches that of an operating context of the device, then the operating context is unlocked and activated. These techniques hide the existence of the operating contexts and provides an improvement to device security.

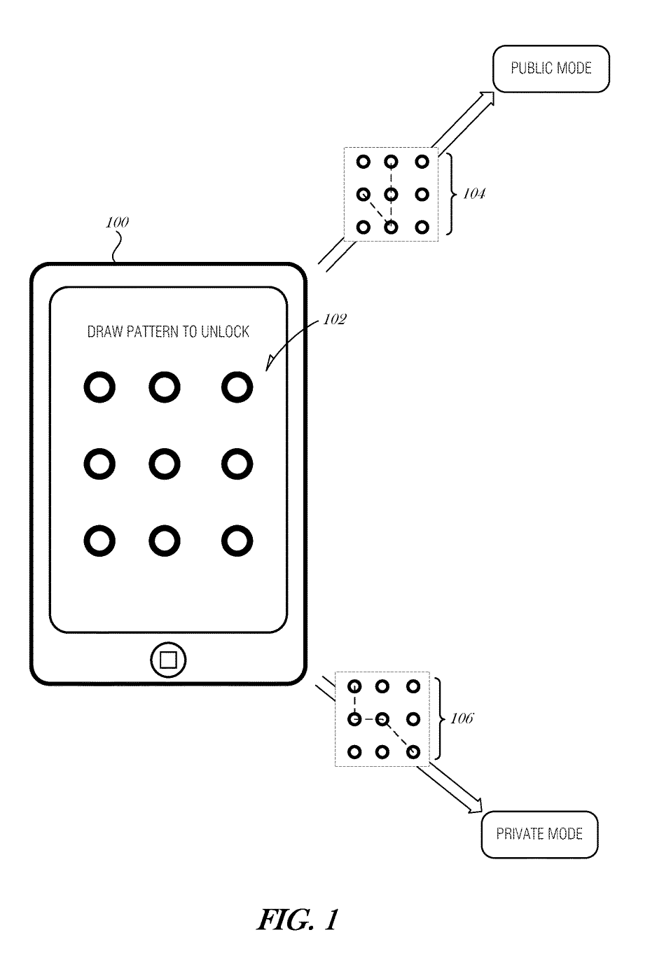

FIG. 1 is a diagram illustrating data and control flow, according to an embodiment. A user device 100 in a locked mode present a lock screen 102. The user device 100 may be any type of compute device including, but not limited to a mobile phone, a smartphone, a phablet, a tablet, a personal digital assistant, a laptop, a digital camera, a desktop computer, or the like. The lock screen 102 may be in various forms, but in the example illustrated in FIG. 1, the lock screen 102 includes a matrix of dots. The dots may be separately activated. To unlock the user device 100, a user begins at one of the dots in the lock screen 102 and traces a path through an additional three dots, for a total of a four dot path, a type of pattern. The pattern is used as an unlock code. The user may set the path/pattern and reset it as desired. Shorter or longer paths/patterns may be used.

The lock screen 102 does not include a list of users, instances, accounts, configurations, or other indicia of the available operating modes or contexts of the user device 100. Instead, the lock screen 102 is a limited lock screen that provides a non-personalized access mechanism. In other words, there is no personalization indicia, such as a username, account name, or the like presented in the limited lock screen. This may be useful when a user wants to implement or have available a separate special mode of operation, but does not want other users to be aware of the existence of such a mode.

For example, an attorney may hide client files in a protected, secure operating context so that if the attorney shares the device casually with another person while it is operating in the public mode, the attorney does not have to worry about exposing sensitive data. Additionally, if the device is lost or stolen, the existence of a protected operating context is completely unknown to others.

As another example, a user may provide a guest password or unlock code to a friend who wishes to use the device. The friend may use the device without knowing that it is in guest mode. The guest mode may be configured to limit access to data or functionality of the device.

When a first recognized path 104 is entered, then the user device 100 unlocks and enters a first mode (e.g., public mode). When a second recognized path 106 is entered, then the user device 100 unlocks and enters a second mode (e.g., a private mode). In the public mode, the user device 100 may act in a typical fashion. The private mode allows the user to browse the Internet, save files in a secure folder, save pictures taken into a secure area, or otherwise act in a manner that is undetectable to a user operating the user device 100 in the public mode.

When the user locks the user device 100, the lock screen 102 may be presented again and depending on the input path provided, the user may activate and unlock either the public mode or private mode of the user device 100. If an unrecognized path is provided to the user device 100, then conventional unlock protocol may be followed (e.g., a limited number of attempts before a complete lock, notification, etc.).

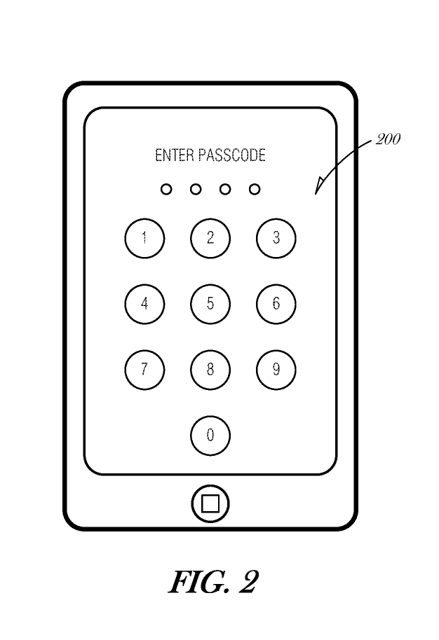

Although FIG. 1 illustrates the use of the system with a pattern-based unlock mechanism, it is understood that other user interfaces may be used. FIGS. 2-4 illustrate optional user interfaces that may be used to provide access control to multi-operating context device without explicitly listing the available operating contexts. The examples illustrated in FIGS. 2-4 are not exhaustive. Thus, while passcodes, paths, passwords, and unlock codes are illustrated, it is understood that other access mechanisms, such as recognizing a pattern in person's iris, detecting a person's face, matching a voice pattern, or recognizing a person's fingerprint may also be used individually or in combination with other access mechanisms discussed herein.

Additionally, although FIG. 1 illustrates the use of the system to unlock the user device 100 in either public mode or a private mode, it is understood that other operating contexts may be accessed using the unlock mechanism described herein.

FIG. 2 is a diagram illustrating a user interface 200, according to an embodiment. A user may enter four digits as a passcode (e.g., a PIN) to unlock the user device 100. Based on the passcode entered, a corresponding operating context is unlocked and activated.

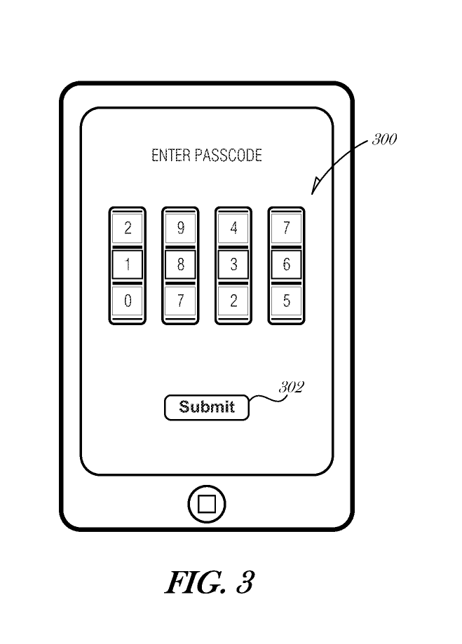

FIG. 3 is a diagram illustrating a user interface 300, according to an embodiment Similar to the user interface 200 illustrated in FIG. 2, a passcode may be entered in the user interface 300 of FIG. 3. Instead of numerical buttons, a rotating control (e.g., akin to a slot machine reel) is used by the user to select each digit. After the digits are selected, a submission control 302 is used to submit the selected passcode for verification.

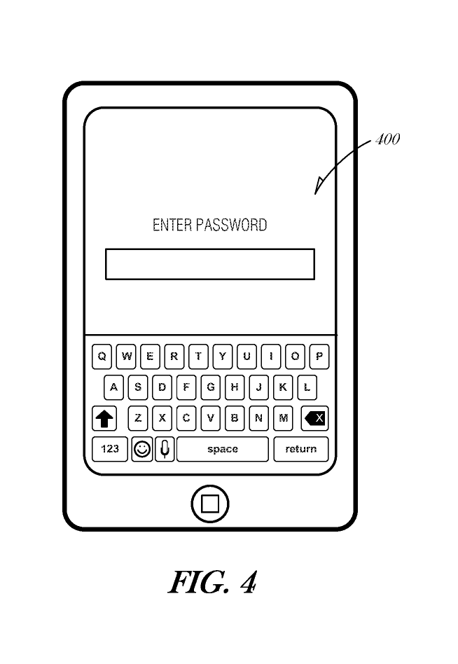

FIG. 4 is a diagram illustrating a user interface 400, according to an embodiment. A user enters an unlock code in the password control 402. The unlock code may be alphanumerical. The unlock code may be include non-alphanumerical symbols, such as ‘*’ or ‘)’ as well. If the unlock code entered matches a known unlock code, then the corresponding operating context is unlocked and activated.

FIGS. 1-4 illustrate various mechanisms to launch into different operational contexts. The actual mechanism to instantiate, login, or other activate an operational context is similar to current processes of logging in or authenticating with conventional systems. In an embodiment, the access control mechanism described in FIGS. 1-4 may be used with existing authentication systems as a pre-login mechanism, capturing the non-personalized unlock mechanism (e.g., a pattern) and passing that to the regular authentication controls with the appropriate credentials (e.g., a username and password) in order to access a secured resource (e.g., a user account, a virtual machine instance, etc.). In such cases, there may be a security manager to authenticate the login attempt and then various layers of access management for disk/file access, printer access, network access, and application control to provide the correct access controls for a user. In the case of a VM or a separate instance of an OS, the security manager may initiate a process to spin up an instance/VM or reattach the main process to the instance/VM. Other authentication protocols and models may be used.

FIG. 5 is a block diagram illustrating a system 500 for access control, according to an embodiment. The system 500 includes a processor 502, a memory 504, and a display 506. The system 500 may be any type of user device. In an embodiment, the user device comprises a tablet device.

The memory 504 may include instructions, which when executed on the processor 502, cause the processor 502 to connect to present a limited lock screen on a display of the user device, wherein the limited lock screen only provides a non-personalized access mechanism

The processor 502 may further receive user input via the limited lock screen. In an embodiment, the non-personalized access mechanism of the limited lock screen includes a matrix of actuation points. In such an embodiment, the instructions to receive the user input include instructions to detect a pattern of the actuation points. In a further embodiment, the pattern of the actuation points is input by the user by swiping the display of the user device.

In an embodiment, the non-personalized access mechanism of the lock screen includes an unlock code field without an associated username selection. In such an embodiment, the instructions to receive user input include instructions to receive an unlock code string via the unlock code field. A username selection may be a username text input field, a user icon of one or more user icons to select from, or a dropdown list of users, for example The non-personalized access mechanism does not use any of these types of username selection mechanisms. The unlock code string may be any sequence of characters, including alphanumeric, punctuation, or symbolic characters.

In an embodiment, the non-personalized access mechanism of the lock screen includes a personal identification number input. In such an embodiment, the instructions to receive the user input include instructions to receive a personal identification number via the personal identification number input. The personal identification number may be a sequence of digits of any length. Some personal identification numbers may be four or five digits.

The processor 502 may further correlate the user input with an operating context, wherein the user input is uniquely correlated with the operating context. In an embodiment, the operating context includes a user account. In another embodiment, the operating context includes a virtual machine. In another embodiment, the operating context includes a private operating mode of the user device. In another embodiment, the operating context includes an instance of an operating environment of the user device, the instance being one of several instances of the operating environment instantiated on the user device.

The processor 502 may further unlock the user device with access to the operating context.

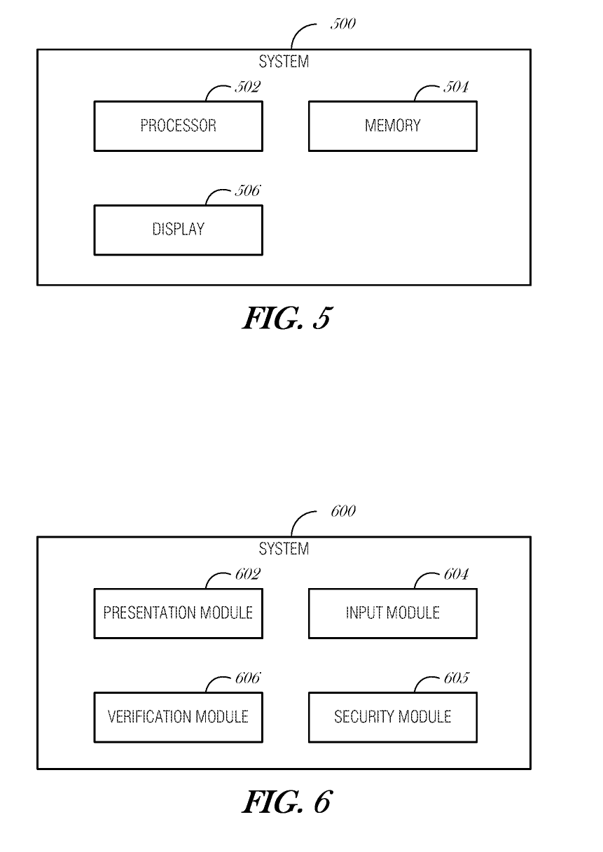

FIG. 6 is a block diagram illustrating a system 600 for access control, according to an embodiment. The system 600 includes a presentation module 602, an input module 604, a verification module 606, and a security module 608.

The presentation module 602 may be configured to present a limited lock screen on a display of the user device, wherein the limited lock screen only provides a non-personalized access mechanism

The input module 604 may be configured to receive user input via the limited lock screen. In an embodiment, the non-personalized access mechanism of the limited lock screen includes a matrix of actuation points, and to receive the user input, the input module 604 is to detect a pattern of the actuation points. In a further embodiment, the pattern of the actuation points is input by the user by swiping the display of the user device.

In an embodiment, the non-personalized access mechanism of the lock screen includes an unlock code field without an associated username selection, and to receive user input, the input module 604 is to receive an unlock code string via the unlock code field.

In an embodiment, the non-personalized access mechanism of the lock screen includes a personal identification number input, and to receive the user input, the input module 604 is to receive a personal identification number via the personal identification number input.

The verification module 606 may be configured to correlate the user input with an operating context, wherein the user input is uniquely correlated with the operating context. For example, using a secure database, the system 600 may perform a lookup with the provided user input and determine whether the user input exists in the secure database and if so, with which operating context the user input is associated. In an embodiment, a one-to-one relationship is held between user inputs and operating contexts. Thus, in such an embodiment, each user input (e.g., unlock code or password) unlocks one and only one operating context. In another embodiment, a many-to-one relationship may exist between user inputs and operating contexts. As such, two users may use different user inputs to access the same operating context.

In an embodiment, the operating context includes a user account. In another embodiment, the operating context includes a virtual machine. In another embodiment, the operating context includes a private operating mode of the user device. In another embodiment, the operating context includes an instance of an operating environment of the user device, the instance being one of several instances of the operating environment instantiated on the user device.

The security module 608 may be configured to unlock the user device with access to the operating context. The operation may include instantiating a virtual machine, logging into a user account, or other setup routines.

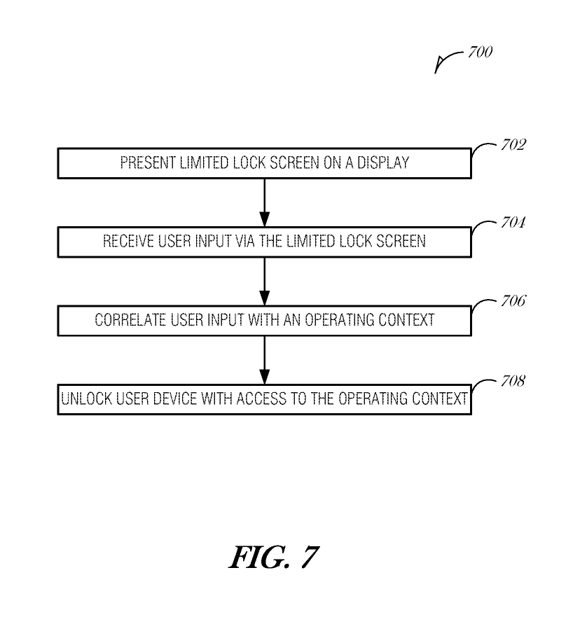

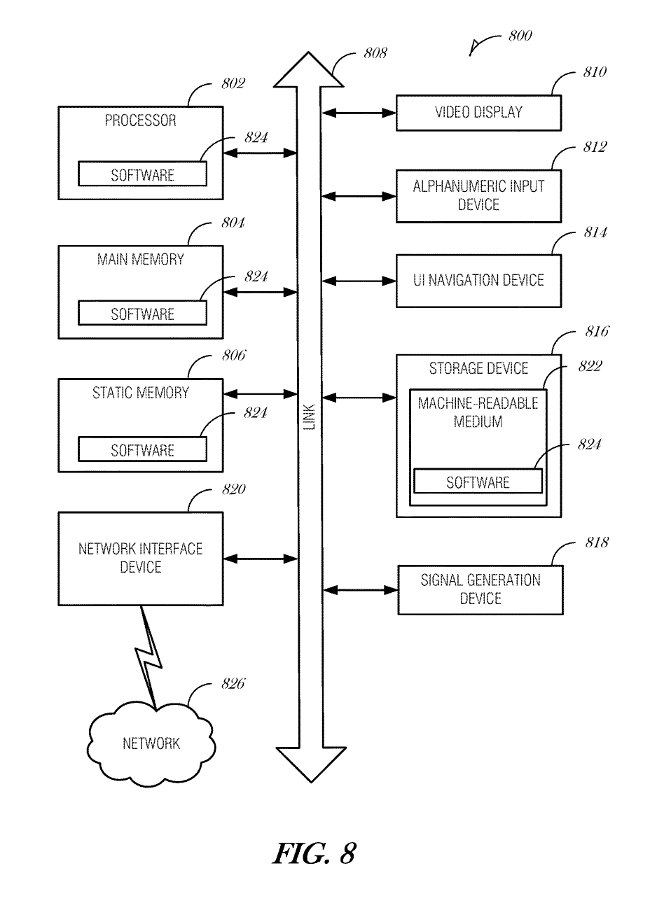

FIG. 7 is a flowchart illustrating a method 700 of providing access control to a user device, according to an embodiment. At block 702, a limited lock screen is presented on a display of the user device, wherein the limited lock screen only provides a non-personalized access mechanism.

At block 704, user input is received via the limited lock screen. In an embodiment, the non-personalized access mechanism of the limited lock screen includes a matrix of actuation points, and receiving user input includes detecting a pattern of the actuation points. In a further embodiment, the pattern of the actuation points is input by the user by swiping the display of the user device.

In an embodiment, the non-personalized access mechanism of the lock screen includes an unlock code field without an associated username selection, and receiving user input includes receiving an unlock code string via the unlock code field.

In an embodiment, the non-personalized access mechanism of the lock screen includes a personal identification number input, and receiving user input includes receiving a personal identification number via the personal identification number input.

At block 706, the user input is correlated with an operating context, wherein the user input is uniquely correlated with the operating context.

In an embodiment, the operating context includes a user account. In another embodiment, the operating context includes a virtual machine. In another embodiment, the operating context includes a private operating mode of the user device. In another embodiment, the operating context includes an instance of an operating environment of the user device, the instance being one of several instances of the operating environment instantiated on the user device.

At block 708, the user device is unlocked with access to the operating context.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules, components, or mechanisms may be hardware, software, or firmware communicatively coupled to one or more processors in order to carry out the operations described herein. Modules may be hardware modules, and as such modules may be considered tangible entities capable of performing specified operations and may be configured or arranged in a certain manner In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for providing access control (such as a device, apparatus, or machine) comprising: a presentation module to present a limited lock screen on a display of the user device, wherein the limited lock screen only provides a non-personalized access mechanism; an input module to receive user input via the limited lock screen; a verification module to correlate the user input with an operating context, wherein the user input is uniquely correlated with the operating context; and a security module to unlock the user device with access to the operating context.

In Example 2, the subject matter of Example 1 may include, wherein the non-personalized access mechanism of the limited lock screen includes a matrix of actuation points, and wherein to receive the user input, the input module is to detect a pattern of the actuation points.

In Example 3, the subject matter of any one of Examples 1 to 2 may include, wherein the pattern of the actuation points is input by the user by swiping the display of the user device.

In Example 4, the subject matter of any one of Examples 1 to 3 may include, wherein the non-personalized access mechanism of the lock screen includes an unlock code field without an associated username selection, and wherein to receive user input, the input module is to receive an unlock code string via the unlock code field.

In Example 5, the subject matter of any one of Examples 1 to 4 may include, wherein the non-personalized access mechanism of the lock screen includes a personal identification number input, and wherein to receive the user input, the input module is to receive a personal identification number via the personal identification number input.

In Example 6, the subject matter of any one of Examples 1 to 5 may include, wherein the operating context includes a user account.

In Example 7, the subject matter of any one of Examples 1 to 6 may include, wherein the operating context includes a virtual machine.

In Example 8, the subject matter of any one of Examples 1 to 7 may include, wherein the operating context includes a private operating mode of the user device.

In Example 9, the subject matter of any one of Examples 1 to 8 may include, wherein the operating context includes an instance of an operating environment of the user device, the instance being one of several instances of the operating environment instantiated on the user device.

Example 10 includes subject matter for providing access control (such as a method, means for performing acts, machine readable medium including instructions that when performed by a machine cause the machine to performs acts, or an apparatus to perform) comprising: presenting a limited lock screen on a display of the user device, wherein the limited lock screen only provides a non-personalized access mechanism; receiving user input via the limited lock screen; correlating the user input with an operating context, wherein the user input is uniquely correlated with the operating context; and unlocking the user device with access to the operating context.

In Example 11, the subject matter of Example 10 may include, wherein the non-personalized access mechanism of the limited lock screen includes a matrix of actuation points, and wherein receiving user input includes detecting a pattern of the actuation points.

In Example 12, the subject matter of any one of Examples 10 to 11 may include, wherein the pattern of the actuation points is input by the user by swiping the display of the user device.

In Example 13, the subject matter of any one of Examples 10 to 12 may include, wherein the non-personalized access mechanism of the lock screen includes an unlock code field without an associated username selection, and wherein receiving user input includes receiving an unlock code string via the unlock code field.

In Example 14, the subject matter of any one of Examples 10 to 13 may include, wherein the non-personalized access mechanism of the lock screen includes a personal identification number input, and wherein receiving user input includes receiving a personal identification number via the personal identification number input.

In Example 15, the subject matter of any one of Examples 10 to 14 may include, wherein the operating context includes a user account.

In Example 16, the subject matter of any one of Examples 10 to 15 may include, wherein the operating context includes a virtual machine.

In Example 17, the subject matter of any one of Examples 10 to 16 may include, wherein the operating context includes a private operating mode of the user device.

In Example 18, the subject matter of any one of Examples 10 to 17 may include, wherein the operating context includes an instance of an operating environment of the user device, the instance being one of several instances of the operating environment instantiated on the user device.

Example 19 includes at least one machine-readable medium including instructions, which when executed by a machine, cause the machine to perform operations of any of the Examples 10-18.

Example 20 includes an apparatus comprising means for performing any of the Examples 10-18.

Example 21 includes subject matter for providing access control (such as a device, apparatus, or machine) comprising: means for presenting a limited lock screen on a display of the user device, wherein the limited lock screen only provides a non-personalized access mechanism; means for receiving user input via the limited lock screen; means for correlating the user input with an operating context, wherein the user input is uniquely correlated with the operating context; and means for unlocking the user device with access to the operating context.

In Example 22, the subject matter of Example 21 may include, wherein the non-personalized access mechanism of the limited lock screen includes a matrix of actuation points, and wherein the means for receiving user input include means for detecting a pattern of the actuation points.

In Example 23, the subject matter of any one of Examples 21 to 22may include, wherein the pattern of the actuation points is input by the user by swiping the display of the user device.

In Example 24, the subject matter of any one of Examples 21 to 23 may include, wherein the non-personalized access mechanism of the lock screen includes an unlock code field without an associated username selection, and wherein the means for receiving user input include means for receiving an unlock code string via the unlock code field.

In Example 25, the subject matter of any one of Examples 21 to 24 may include, wherein the non-personalized access mechanism of the lock screen includes a personal identification number input, and wherein the means for receiving user input include means for receiving a personal identification number via the personal identification number input.

In Example 26, the subject matter of any one of Examples 21 to 25 may include, wherein the operating context includes a user account.

In Example 27, the subject matter of any one of Examples 21 to 26 may include, wherein the operating context includes a virtual machine.

In Example 28, the subject matter of any one of Examples 21 to 27 may include, wherein the operating context includes a private operating mode of the user device.

In Example 29, the subject matter of any one of Examples 21 to 28 may include, wherein the operating context includes an instance of an operating environment of the user device, the instance being one of several instances of the operating environment instantiated on the user device.

Example 30 includes subject matter (such as a device, apparatus, or machine) comprising: a display; a processor; and a memory, including instructions, which when executed on the processor, cause the processor to: present a limited lock screen on a display of the user device, wherein the limited lock screen only provides a non-personalized access mechanism; receive user input via the limited lock screen; correlate the user input with an operating context, wherein the user input is uniquely correlated with the operating context; and unlock the user device with access to the operating context.

In Example 31, the subject matter of Example 30 may include, wherein the non-personalized access mechanism of the limited lock screen includes a matrix of actuation points, and wherein the instructions to receive the user input include instructions to detect a pattern of the actuation points.

In Example 32, the subject matter of any one of Examples 30 to 31 may include, wherein the pattern of the actuation points is input by the user by swiping the display of the user device.

In Example 33, the subject matter of any one of Examples 30 to 32 may include, wherein the non-personalized access mechanism of the lock screen includes an unlock code field without an associated username selection, and wherein the instructions to receive user input include instructions to receive an unlock code string via the unlock code field.

In Example 34, the subject matter of any one of Examples 30 to 33 may include, wherein the non-personalized access mechanism of the lock screen includes a personal identification number input, and wherein the instructions to receive the user input include instructions to receive a personal identification number via the personal identification number input.

In Example 35, the subject matter of any one of Examples 30 to 34 may include, wherein the operating context includes a user account.

In Example 36, the subject matter of any one of Examples 30 to 35 may include, wherein the operating context includes a virtual machine.

In Example 37, the subject matter of any one of Examples 30 to 36 may include, wherein the operating context includes a private operating mode of the user device.

In Example 38, the subject matter of any one of Examples 30 to 37 may include, wherein the operating context includes an instance of an operating environment of the user device, the instance being one of several instances of the operating environment instantiated on the user device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-20. (canceled)

21. A system for providing access control, the system comprising:
a presentation module to present a limited lock screen on a display of the user device, wherein the limited lock screen only provides a non-personalized access mechanism;
an input module to receive user input via the limited lock screen;
a verification module to correlate the user input with an operating context, wherein the user input is uniquely correlated with the operating context; and
a security module to unlock the user device with access to the operating context.

22. The system of claim 21, wherein the non-personalized access mechanism of the limited lock screen includes a matrix of actuation points, and wherein to receive the user input, the input module is to detect a pattern of the actuation points.

23. The system of claim 22, wherein the pattern of the actuation points is input by the user by swiping the display of the user device.

24. The system of claim 21, wherein the non-personalized access mechanism of the lock screen includes an unlock code field without an associated username selection, and wherein to receive user input, the input module is to receive an unlock code string via the unlock code field.

25. The system of claim 21, wherein the non-personalized access mechanism of the lock screen includes a personal identification number input, and wherein to receive the user input, the input module is to receive a personal identification number via the personal identification number input.

26. The system of claim 21, wherein the operating context includes a user account.

27. The system of claim 21, wherein the operating context includes a virtual machine.

28. The system of claim 21, wherein the operating context includes a private operating mode of the user device.

29. The system of claim 21, wherein the operating context includes an instance of an operating environment of the user device, the instance being one of several instances of the operating environment instantiated on the user device.

30. A method of providing access control to a user device, the method comprising:
presenting a limited lock screen on a display of the user device, wherein the limited lock screen only provides a non-personalized access mechanism;
receiving user input via the limited lock screen;
correlating the user input with an operating context, wherein the user input is uniquely correlated with the operating context; and
unlocking the user device with access to the operating context.

31. The method of claim 30, wherein the non-personalized access mechanism of the limited lock screen includes a matrix of actuation points, and wherein receiving user input includes detecting a pattern of the actuation points.

32. The method of claim 31, wherein the pattern of the actuation points is input by the user by swiping the display of the user device.

33. The method of claim 30, wherein the non-personalized access mechanism of the lock screen includes an unlock code field without an associated username selection, and wherein receiving user input includes receiving an unlock code string via the unlock code field.

34. The method of claim 30, wherein the non-personalized access mechanism of the lock screen includes a personal identification number input, and wherein receiving user input includes receiving a personal identification number via the personal identification number input.

35. The method of claim 30, wherein the operating context includes a user account.

36. The method of claim 30, wherein the operating context includes a virtual machine.

37. The method of claim 30, wherein the operating context includes a private operating mode of the user device.

38. The method of claim 30, wherein the operating context includes an instance of an operating environment of the user device, the instance being one of several instances of the operating environment instantiated on the user device.

39. At least one non-transitory machine-readable medium including instructions, which when executed by a machine, cause the machine to:
present a limited lock screen on a display of the user device, wherein the limited lock screen only provides a non-personalized access mechanism;
receive user input via the limited lock screen;
correlate the user input with an operating context, wherein the user input is uniquely correlated with the operating context; and
unlock the user device with access to the operating context.

40. The at least one non-transitory machine-readable medium of claim 39, wherein the non-personalized access mechanism of the limited lock screen includes a matrix of actuation points, and wherein the instructions to receive the user input include instructions to detect a pattern of the actuation points.

41. The at least one non-transitory machine-readable medium of claim 40, wherein the pattern of the actuation points is input by the user by swiping the display of the user device.

42. The at least one non-transitory machine-readable medium of claim 39, wherein the non-personalized access mechanism of the lock screen includes an unlock code field without an associated username selection, and wherein the instructions to receive user input include instructions to receive an unlock code string via the unlock code field.

43. A system for providing access control, the system comprising:
a display;
a processor; and
a memory, including instructions, which when executed on the processor, cause the processor to:
present a limited lock screen on a display of the user device, wherein the limited lock screen only provides a non-personalized access mechanism;
receive user input via the limited lock screen;
correlate the user input with an operating context, wherein the user input is uniquely correlated with the operating context; and
unlock the user device with access to the operating context.

44. The system of claim 43, wherein the non-personalized access mechanism of the limited lock screen includes a matrix of actuation points, and wherein the instructions to receive the user input include instructions to detect a pattern of the actuation points.

45. The system of claim 43, wherein the operating context includes a private operating mode of the user device.
